(19) United States
(12) Patent Application Publication
(10) Pub. No.: US 2009/0239114 A1
(43) Pub. Date: Sep. 24, 2009

(54) POLYMER ELECTROLYTE FUEL CELL

(75) Inventors: Yasutaka Kouno, Tokyo (JP); Satoshi Tomoeda, Tokyo (JP); Yoshimi Kubo, Tokyo (JP); Tsutomu Yoshitake, Tokyo (JP); Takeshi Obata, Tokyo (JP)

Correspondence Address: KATTEN MUCHIN ROSENMAN LLP, 575 MADISON AVENUE, NEW YORK, NY, 10022-2585, US

(73) Assignee: NEC CORPORATION, Tokyo (JP)

(21) Appl. No.: 11/721,297

(22) PCT Filed: Sep. 12, 2005
(86) PCT No.: PCT/JP2005/016706

§ 371 Date: Jun. 8, 2007

(30) Foreign Application Priority Data
Dec. 17, 2004 (JP) 2004-366502

(51) Int. Cl. H01M 8/10

(52) U.S. Cl. 429/30

(57) ABSTRACT

A polymer electrolyte fuel cell which has a polymer electrolyte membrane, an anode disposed on one side of the polymer electrolyte membrane and a cathode disposed on the other side of the polymer electrolyte membrane, wherein an organic fuel is supplied to the anode, and wherein the anode has an anode catalyst layer containing a catalyst and a proton-conducting material, and the cathode has a cathode catalyst layer containing a catalyst, a proton-conducting material and an oxygen-permeating material.

### TECHNICAL FIELD

The present invention relates to a polymer electrolyte fuel cell, particularly to a fuel cell suitable for a system where an organic fuel is directly supplied.

### BACKGROUND ART

A polymer electrolyte fuel cell is a power generation device comprising a polymer electrolyte membrane which is, on both sides, sandwiched between a cathode and an anode, providing current by an electrochemical reaction while supplying an oxidizing agent such as oxygen in the air to the cathode and a reducing agent (fuel) such as hydrogen to the anode.

Among such polymer electrolyte fuel cells, a liquid-fuel direct-supply type fuel cell using an organic liquid fuel such as methanol as a fuel which is directly supplied is safer than that using a gas fuel such as hydrogen gas, and has the advantages of size reduction and simplification because no apparatus for gasifying or reforming a fuel is required.

For example, a known example of a direct methanol fuel cell using an aqueous methanol solution as an organic liquid fuel is that comprising an electrolyte membrane containing a proton-conductive polymer such as a perfluorosulfonic acid membrane which is, on both sides, sandwiched between catalyst layers containing a platinum catalyst. In such a fuel cell, electrons, protons and carbon dioxide are generated in the anode side by a catalyzed reaction of the aqueous methanol solution supplied, while water is generated in the cathode side by a catalyzed reaction of protons transferring from the anode side through the electrolyte membrane with oxygen supplied.

However, in such a polymer electrolyte fuel cell, byproducts are produced while electric generation, and it is known that when using an aqueous methanol solution as a fuel, there are formed byproducts such as formaldehyde, formic acid and methyl formate It has been needed to reduce generation of such byproducts as much as possible in the light of, for example, environmental regulation.

Byproducts are predominantly formed by a so-called crossover phenomenon where an unconsumed fuel supplied to an anode transfers through an electrolyte membrane to a cathode side and is then subjected to a catalyzed reaction to generate a back electromotive force. Here, the fuel transferring from the anode side through the electrolyte membrane to the cathode side is not completely oxidized in the cathode side and such incomplete combustion leads to generation of byproducts. When using an aqueous methanol solution as a fuel, methanol which has reached the cathode side is not completely oxidized to carbon dioxide while giving byproducts such as formaldehyde, formic acid and methyl formate. Furthermore, the byproducts generated in the anode side would transfer through the electrolyte membrane together with the fuel to the cathode side.

For solving such problems associated with byproduct formation, the following techniques have been, for example, disclosed.

Patent Reference 1 (Japanese Laid-open Patent Publication No. 2003-223920) has disclosed a liquid-fuel direct supply type fuel cell system (specifically, a direct methanol fuel cell system) comprising a gas/liquid separation tank for separating a gas and a liquid from a reaction product in an electrode and a filter for absorbing and decomposing byproducts in the separated gaseous component in order to preventing the byproducts from being discharged to the outside.

Patent Reference 2 (Japanese Laid-open Patent Publication No. 2003-297401) has disclosed a liquid-fuel direct supply type fuel cell system (specifically, a direct methanol fuel cell system), comprising a cathode collecting vessel communicated with an outlet in a cathode channel through which an oxidizing agent passes; a gas/liquid contacting mechanism for contacting the material discharged from the outlet with water in the cathode collecting vessel; and a mechanism for feeding the aqueous solution collected in the cathode collecting vessel to a fuel storing vessel, in order to minimize an output reduction and preventing the byproducts from being discharged.

### DISCLOSURE OF THE INVENTION

In the above prior art, the technique involving a filter has problems such as a cost for filter exchanging and the necessity for exchanging a filter after user's perceiving the optimal timing of exchange because a filter has an operating life. The technique where a separate collecting apparatus is used for preventing byproducts from being discharged, inevitably leads to a complex apparatus, impairs the advantage of the ability to size-reduce and simplify the system, and adversely affects long-term reliability.

Thus, an objective of the present invention is to provide a polymer electrolyte fuel cell in which discharge of byproducts is significantly reduced while allowing for size reduction, for solving the above problems.

The present invention relates to a polymer electrolyte fuel cell comprising a polymer electrolyte membrane, an anode disposed on one side of the polymer electrolyte membrane and a cathode disposed on the other side of the polymer electrolyte membrane, wherein an organic fuel is supplied to the anode, and

wherein the anode comprises an anode catalyst layer containing a catalyst and a proton-conducting material, and

the cathode comprises a cathode catalyst layer containing a catalyst, a proton-conducting material and an oxygen-permeating material.

The present invention also relates to the polymer electrolyte fuel cell as described above, wherein the oxygen-permeating material is a material having an oxygen-permeability coefficient, Dk, larger than that of water.

The present invention also relates to the polymer electrolyte fuel cell as described above, wherein the oxygen-permeating material is a non-ionic polymer compound containing oxygen atoms.

The present invention also relates to the polymer electrolyte fuel cell as described above, wherein the oxygen-permeating material is a methacrylate polymer compound or cellulose polymer compound.

The present invention also relates to the polymer electrolyte fuel cell as described above, wherein the proton-conducting material is a polymer compound having a proton-exchanging group.

The present invention also relates to the polymer electrolyte fuel cell as described above, wherein in the cathode catalyst layer, a content weight ratio of the oxygen-permeating material to the proton-conducting material is 2/98 to 30/70.

The present invention also relates to the polymer electrolyte fuel cell as described above, wherein the organic fuel is a liquid.

The present invention also relates to the polymer electrolyte fuel cell as described above, wherein the organic fuel is an aqueous alcohol solution.

According to the present invention, there can be provided a polymer electrolyte fuel cell allowing for size reduction while significantly reducing discharge of byproducts. In the present invention, a fuel that reaches the cathode side through an electrolyte membrane from the anode side can be adequately oxidized by incorporating an oxygen-permeating material in a catalyst layer in the cathode side to improve the status of oxygen supply, so that byproduct generation can be minimized in the cathode side.

A polymer electrolyte fuel cell according to the present invention can be applied to a small portable devices such as a cell phone, a laptop computer, a PDA (Personal Digital Assistance), a camera, a navigation system and a portable music player because it makes size reduction easier and reduces byproduct generation.

### BRIEF DESCRIPTION OF THE DRAWINGS

FIG. 1 is a schematic cross-sectional view illustrating an embodiment of a fuel cell according to the present invention.

### BEST MODE FOR CARRYING OUT THE INVENTION

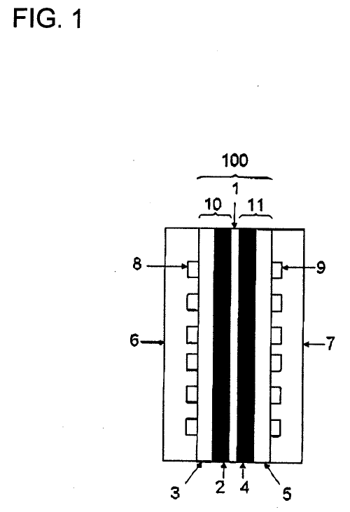

FIG. 1 is a schematic cross-sectional view of an embodiment of a fuel cell according to the present invention. There are disposed an anode 10 and a cathode 11 on the sides of a polymer electrolyte membrane 1 such that they face each other, to form a membrane electrode assembly 100, which is generally called an MEA (Membrane and Electrode Assembly). The anode 10 is comprised of an anode catalyst layer 2 formed in the side of the electrolyte membrane 1 and an anodic diffusion electrode 3 formed on the catalyst layer, while the cathode 11 is comprised of a cathode catalyst layer 4 formed in the side of the electrolyte membrane 1 and a cathodic diffusion electrode 5 formed on the catalyst layer. These diffusion electrodes are made of a conductive porous material. When a plurality of the electrode-electrolyte membrane assemblies 100 are connected, for example, they can be stacked via separators 6, 7 and are electrically serially connected to form a stack structure. Here, there is a fuel supply channel 8 between the anodic diffusion electrode 3 and the separator 6 for supplying a fuel, while there is an oxidizing agent supply channel 9 between the cathodic diffusion electrode 5 and the separator 7 for supplying an oxidizing agent.

In the above fuel cell, an organic fuel such as an aqueous methanol solution is supplied as a fuel to the side of the anode 10. The supplied fuel passes through pores in the anodic diffusion electrode 3 to the anode catalyst layer 2, and is subjected to a catalyst reaction to generate electrons, protons and carbon dioxide. The proton transfer through the electrolyte membrane 1 to the cathode 11, while the electrons transfer through the anodic diffusion electrode 3 and an external circuit to the cathode 11.

On the other hand, an oxidizing agent such as air is supplied to the side of the cathode 11. The supplied oxidizing agent pass through pores in the cathodic diffusion electrode 5 to the cathode catalyst layer 4, and is subject to a catalyst reaction with the protons from the electrolyte membrane 1 and the electrons from the external circuit to generate water.

As described above, electrons flow from the anode 10 through the external circuit toward the cathode 11, to generate electric power.

A polymer electrolyte membrane in a fuel cell of the invention contributes to electric separation between an anode and a cathode as well as transfer of protons (hydrogen ions) between the electrodes. The polymer electrolyte membrane is hence preferably a membrane having higher proton conductivity. Furthermore, it is preferably chemically stable to a fuel and an oxidizing agent used and mechanically strong. Examples of a material for such a polymer electrolyte membrane include polymers having a protonic acid group such as a sulfonic acid group, a sulfoalkyl group, a phosphoric acid group, a phosphonic group, a phosphinic group, a carboxyl group and a sulfonimide group. Among others, an organic polymer having a sulfonic acid group as an ion exchange group can be suitably used.

In a polymer having such a protonic acid group, examples of a base polymer having a protonic acid group include polyether ketones, polyether ether ketones, polyether sulfones, polyether ether sulfones, polysulfones, polysulfides, polyphenylenes, polyphenylene oxides, polystyrenes, polyimides, polybenzimidazoles and polyamides. In the light of reducing crossover in a liquid fuel such as methanol, a non-fluorinated hydrocarbon polymer can be used as a base polymer. Furthermore, an aromatic-containing polymer may be used as a base polymer.

Other examples of a base polymer include nitrogen- or hydroxy-containing resins such as polybenzimidazole derivatives, polybenzoxazole derivatives, polyethyleneimine cross-linked compounds, polysilamine derivatives, amine-substituted polystyrenes including polydiethylaminoethylstyrene, nitrogen-substituted poly(meth)acrylates such as polydiethylaminoethyl methacrylate; silanol-containing polysiloxanes; hydroxy-containing poly(meth)acrylic resins such as polyhydroxyethyl methacrylates; and hydroxy-containing polystyrene resins such as poly(p-hydroxystyrenes).

The above polymers optionally having a crosslinking or crosslinked substituent such as vinyl, epoxy, acrylic, methacrylic, cinnamoyl, methylol, azide and naphthoquinonediazide can be used.

Specific examples of a polymer electrolyte membrane include sulfonated polyether ether ketones; sulfonated polyether sulfones; sulfonated polyether ether sulfones; sulfonated polysulfones; sulfonated polysulfides; sulfonated polyphenylenes; aromatic-containing polymers such as sulfonated poly(4-phenoxybenzoyl-1,4-phenylenes) and alkylsulfonated polybenzimidazoles; sulfoalkylated polyether ether ketones; sulfoalkylated polyether sulfones; sulfoalkylated polyether ether sulfones; sulfoalkylated polysulfones; sulfoalkylated polysulfides; sulfoalkylated polyphenylenes; sulfonic-acid containing perfluorocarbons (for example, Nafion®, DuPont; Aciplex®, Asahi Kasei Corporation); carboxyl-containing perfluorocarbons (for example, Flemion®-S membrane, Asahi Glass Co., Ltd.); copolymers such as polystyrene sulfonic acid copolymers, polyvinylsulfonic acid copolymers, cross-linked alkylsulfonic acid derivatives, and fluorine-containing polymers including a fluororesin framework and a sulfonic acid; and copolymers prepared by copolymerizing an acrylamide such as acrylamide-2-methylpropanesulfonic acid with a (meth)acrylate such as n-butyl methacrylate. Additional examples include aromatic polyether ether ketones or aromatic polyether ketones having a protonic acid group such as a sulfonic acid group.

The cathodic diffusion electrode and the anodic diffusion electrode may be made of a conductive porous base material such as a carbon paper, a molded carbon, a sintered carbon, a sintered metal and a foam metal. These diffusion electrodes can be appropriately subjected to water-repellent finishing or hydrophilization.

Examples of a suitable catalyst in the anode or cathode include platinum and alloys containing platinum as a main component such as platinum-ruthenium alloys (hereinafter, referred to as a “platinum alloy”). Additional examples of a platinum alloy include alloys with a metal such as rhenium, rhodium, palladium, iridium, ruthenium, gold and silver. The catalysts for the anode and the cathode may be the same or different. A content of a catalyst metal in a catalyst layer is preferably 20 to 60 wt %, more preferably 20 to 40 wt % in the light of an adequate electrode reaction. A size of catalyst particles used may be 0.001 to 0.05 μm.

The catalyst is preferably catalyst particles supported by a conductive material such as a carbon material. Examples of a conductive material (carrier) on which a catalyst is to be supported include carbon blacks such as acetylene black (for example, Denka Black®, DENKI KAGAKU KOGYO KABUSHIKI KAISHA) and ketjen black; and carbon nanomaterials represented by carbon nanotube and carbon nanohorn aggregate. A carbon content in the catalyst layer is preferably 30 to 60 wt %, more preferably 40 to 50 wt % in the light of achieving adequate electron conductivity and catalyst activity. A particle size of the carbon material may be, for example, 0.01 to 0.1 μm.

The separators 6, 7 may be made of an anticorrosive conductive material which is impermeable to a fuel or an oxidizing agent such as anticorrosive metals and graphite.

The fuel supply channel 8 and the oxidizing agent supply channel 9 are responsible for delivering a fuel or oxidizing agent to an electrode surface, and can be formed in a separator. Alternatively, they may be formed using a known conductive material as a separate part from the separator. A member for delivering a fuel or oxidizing agent to an electrode surface (delivering member) may be a conductive plate having channels or a porous conductive sheet made of, for example, porous carbon. A delivering member or diffusion electrode as a separate part from the separator can be used in place of the supply channels 8, 9, to omit the supply channels 8, 9.

A fuel cell of this invention, which has the above basic configuration, is characterized in that a cathode comprises a catalyst layer containing a catalyst, a proton-conducting material and an oxygen-permeating material.

The catalyst may be selected from the above catalysts, suitably catalyst particles supported by a conductive material such as a carbon material.

There are no particular restrictions to a proton-conducting material as long as it is water-resistant and allows protons to be rapidly conducted in the catalyst layer, and it may be selected from the above polymers used as a polymer electrolyte membrane.

The oxygen-permeating material may be suitably a water-resistant oxygen-containing non-ionic polymer compound. Preferable examples of such a polymer compound include methacrylate polymer compounds and cellulose polymer compounds. Examples of a methacrylate polymer compound include hydroxyethyl methacrylate polymers, trifluoroethyl methacrylate polymers, hexafluoroisopropyl methacrylate polymers and perfluorooctylethyl methacrylate polymers. An example of a cellulose polymer compound is cellulose acetate butyrate.

An oxygen-permeating material preferably has an oxygen-permeability coefficient (Dk) higher than that of water. That is, a Dk ratio of the oxygen-permeating material to water (a Dk value of the oxygen-permeating material/a Dk value of water) is preferably more than 1, more preferably more than 1.1. An oxygen-permeability coefficient (Dk) is a product of a diffusion coefficient (D) representing a degree of oxygen diffusion in a material multiplied by a solubility (k) representing a degree of oxygen dissolution in a material, and is expressed in a unit [(cm²/sec)·(ml O₂/ml·mmHg)](=[(cm²/sec)·(ml O₂/ml·hPa)/1.33]).

The catalyst layer may contain, if necessary, a water repellant such as polytetrafluoroethylene and a conductivity-imparting agent such as carbon.

In the catalyst layer, a content weight ratio of the oxygen-permeating material to the proton-conducting material is preferably 2/98 to 30/70, more preferably 5/95 to 30/70, further preferably 10/90 to 20/80. If a content of the oxygen-permeating material is too low, oxygen is inadequately supplied in the catalyst layer, leading to inadequate prevention of byproduct generation. If the oxygen-permeating material is contained too much, the proton-conducting material is too reduced to adequately transfer protons in the catalyst layer, leading to impairment of an electrode reaction.

In the catalyst layer, the total content of the proton-conducting material and the oxygen-permeating material is preferably 20 to 50 wt %, more preferably 30 to 40 wt % to the total amount of the catalyst layer. If the total content is too high, a required amount of the catalyst cannot be ensured, leading to deterioration in electron conductivity and a reduced energy conversion efficiency such as output reduction. If the total content is too low, oxygen and protons in the catalyst layer cannot adequately move, leading to insufficient prevention of byproduct generation or an electrode reaction.

A content of the oxygen-permeating material in the catalyst layer is preferably 1 wt % or more, more preferably 2 wt % or more and preferably 15 wt % or less, more preferably 10 wt % or less, to the total amount of the catalyst layer. If a content of the oxygen-permeating material is too low, byproduct generation can be inadequately prevented, while if it is too high, a content of the catalyst or the proton-conducting material is too low for an electrode reaction to adequately proceed.

As described above, in the cathodic catalyst layer which contains the oxygen-permeating material, the status of oxygen supply is so improved that the fuel fed from the anode side through the electrolyte membrane to the cathode side can be adequately oxidized, resulting in preventing byproducts from being generated in the cathode side.

In the cathode side, there exist generated water from the electrode reaction and moving water permeating the electrolyte membrane, which cover the catalyst surface to impair an adequate oxidation reaction. The status of oxygen supply can be, however, improved by using an oxygen-permeating material, particularly a material having a higher Dk value than that of water in the catalyst layer in the cathode side. Furthermore, the proton-conducting material in the catalyst layer can be partly replaced with the oxygen-permeating material as long as proton conductivity is not impaired, to improve the status of oxygen supply and prevent byproduct generation while allowing an electrode reaction to adequately proceed.

The anode has the same configuration as that of the cathode, except that the anode comprises a catalyst layer containing a catalyst and a proton-conducting material and that an oxygen-permeating material is not an essential component. The anode may contain an oxygen-permeating material within such a range that desired battery properties can be obtained.

A fuel cell of this embodiment can be, for example, as described below.

First, a catalyst is supported on carbon particles by a common supporting process such as impregnation. The supported catalyst, a proton-conducting material, an oxygen-permeating material and, if necessary, a water repellant are dispersed and mixed in a solvent, and the resulting mixture is applied on a substrate such as a diffusion electrode, which is then dried to give a cathode catalyst layer. An anode catalyst layer can be formed as described for the cathode catalyst layer, except that an oxygen-permeating material is not used.

A polymer electrolyte membrane can be prepared by, for example, applying a solution of a polymer electrolyte on a peelable plate such as polytetrafluoroethylene, and then drying and peeling it.

The polymer electrolyte membrane thus prepared is sandwiched between an anode and a cathode such that the polymer electrolyte membrane is in contact with the cathode catalyst layer and the anode catalyst layer, and the resulting laminate is hot-pressed to provide a membrane electrode assembly 100.

This invention is effective for a fuel cell where a fuel is an organic fuel which may generate byproducts by a catalyst reaction, particularly for a fuel cell using a liquid fuel. Examples of such a liquid fuel include oxygen-containing organic fuels including alcohols such as methanol and ethanol and ethers such as dimethyl ether. Among others, preferred is an alcohol such as methanol, which can be used as an aqueous solution. The oxidizing agent may be the air or oxygen.

### EXAMPLES

### Example 1

A direct methanol fuel cell was prepared, which had the configuration shown in FIG. 1 and where a cathode catalyst layer 4 in a cathode 11 contained an oxygen-permeating material.

A catalyst contained in an anode catalyst layer 2 and a cathode catalyst layer 4 was catalyst-supporting carbon particles in which a platinum (Pt)-ruthenium (Ru) alloy with a particle size of 3 to 5 nm was supported on carbon particles (trade name: Denka Black®, DENKI KAGAKU KOGYO KABUSHIKI KAISHA). The alloy has a composition of 50 wt % Pt and a weight ratio of the alloy to the carbon particles (the alloy/the carbon particles) was 1.

The catalyst-supporting carbon particles was mixed with a 5 wt % Nafion solution (Aldrich Chemical Company, Inc.) as a proton-conducting material solution, to prepare a catalyst paste for an anode. A weight ratio of the proton-conducting material to the catalyst-supporting carbon particles (the proton-conducting material/the catalyst-supporting carbon particles) was 10/90.

Separately, a catalyst paste for a cathode was prepared by mixing a catalyst-supporting carbon particles, a 5 wt % Nafion solution and a trifluoroethyl methacrylate polymer as an oxygen-permeating material. A weight ratio of the catalyst-supporting particles, the proton-conducting material and the oxygen-permeating material (the proton-conducting material/the catalyst-supporting carbon particles/the oxygen-permeating material) was 8/90/2.

The trifluoroethyl methacrylate polymer had an oxygen-permeability coefficient Dk of 120×10⁻¹¹. Water has an oxygen-permeability coefficient Dk of 93×10⁻¹¹ as calculated from a diffusion coefficient (D) and a solubility (K).

Each of these catalyst pastes was applied on a carbon paper which had been made water-repellent with polytetrafluoroethylene (trade name: TGP-H-120, Toray Industries, Inc.) to 2 mg/cm² by screen printing and then dried by heating at 120° C. to prepare an anode 10 and a cathode 11.

The anode and the cathode thus prepared were thermally compressed on a polymer electrolyte membrane (trade name: Nafion®, DuPont, film thickness: 150 μm) at 120° C., to prepare a unit cell for a fuel cell.

To the anode in the unit cell obtained was supplied a 10 wt % aqueous methanol solution at a rate of 2 ml/min, and then an open voltage of 0.9 V and a short-circuit current of 0.25 A/cm² were observed. Table 1 shows an amount of a gas (formaldehyde) generated in the fuel cell as determined by the method below.

### Example 2

A unit cell for a fuel cell was prepared as described in Example 1, except that a cellulose acetate butyrate polymer was used as an oxygen permeating-material. The cellulose acetate butyrate had an oxygen-permeability coefficient Dk of 110×10⁻¹¹.

To the anode in the unit cell obtained was supplied a 10 wt % aqueous methanol solution at a rate of 2 ml/min, and then an open voltage of 0.9 V and a short-circuit current of 0.25 A/cm² were observed. Table 1 shows an amount of a gas (formaldehyde) generated in the fuel cell as determined by the method below.

### Comparative Example

A unit cell for a fuel cell was prepared as described in Example 1, without using an oxygen-permeating material.

To the anode in the unit cell obtained was supplied a 10 wt % aqueous methanol solution at a rate of 2 ml/min, and then an open voltage of 0.9 V and a short-circuit current of 0.25 A/cm² were observed. Table 1 shows an amount of a gas (formaldehyde) generated in the fuel cell as determined by the method below.

### Determination of an Oxygen-Permeability Coefficient and a Generated Gas Amount

An oxygen-permeability coefficient was determined in accordance with ISO 9913-2. A gas generated from a cell was analyzed as follows in accordance with JIS A1901. A fuel cell was placed in a chamber, a discharged gas was collected, and the discharged gas was fixed on a fixing filter, which was then analyzed by liquid chromatography.

TABLE 1

| | Amount of formaldehyde (ppb) |
|---|---|
| Example 1 | 30 |
| Example 2 | 35 |
| Comparative Example | 50 |

1. A polymer electrolyte fuel cell comprising a polymer electrolyte membrane, an anode disposed on one side of the polymer electrolyte membrane and a cathode disposed on the other side of the polymer electrolyte membrane, wherein an organic fuel is supplied to the anode;
wherein the anode comprises an anode catalyst layer containing a catalyst and a proton-conducting material, and
the cathode comprises a cathode catalyst layer containing a catalyst, a proton-conducting material and an oxygen-permeating material; and
wherein the organic fuel is a liquid.

2. The polymer electrolyte fuel cell as claimed in claim 1, wherein the oxygen-permeating material is a material having an oxygen-permeability coefficient, Dk, larger than that of water.

3. The polymer electrolyte fuel cell as claimed in claim 1, wherein the oxygen-permeating material is a non-ionic polymer compound containing oxygen atoms.

4. The polymer electrolyte fuel cell as claimed in claim 1, wherein the oxygen-permeating material is a methacrylate polymer compound or cellulose polymer compound.

5. The polymer electrolyte fuel cell as claimed in claim 1, wherein the proton-conducting material is a polymer compound having a proton-exchanging group.

6. The polymer electrolyte fuel cell as claimed in claim 1, wherein in the cathode catalyst layer, a content weight ratio of the oxygen-permeating material to the proton-conducting material is 2/98 to 30/70.

7. (canceled)

8. The polymer electrolyte fuel cell as claimed in claim 1, wherein the organic fuel is an aqueous alcohol solution.
